(19) United States
(12) Patent Application Publication
(10) Pub. No.: US 2024/0189875 A1
(43) Pub. Date: Jun. 13, 2024

(54) SYSTEM AND A METHOD FOR INJECTION MOLDING PVC, ADHESIVE AND PAPER PRODUCTS

(71) Applicant: American Renolit Corporation, La Porte, IN (US)

(72) Inventors: Markus Bender, La Porte, IN (US); Jacqueline M. Hazzard-Reed, La Porte, IN (US)

(21) Appl. No.: 18/514,773

(22) Filed: Nov. 20, 2023

Related U.S. Application Data
(60) Provisional application No. 63/386,985, filed on Dec. 12, 2022.

(51) Int. Cl. B09B 3/35; B29B 9/10; B29B 17/04

(52) U.S. Cl. CPC B09B 3/35; B29B 9/10; B29B 17/0412; B09B 2101/75

(57) ABSTRACT

A system, apparatus, and method for processing waste materials and creating mixed-content-recyclates (MCRs) from two or more types of material. The system can include an injection molder configured to create a product by injection molding the mixed-content-recyclates. The system can be configured to create MCRs from recycling materials such as plastics, adhesives, and paper products, including, but not limited to, for example: polyvinyl chloride (PVC) films such as monomeric, polymeric, plasticized PVC, non-plasticized PVC, and PVC blends; adhesives such as polyacrylate adhesives and rubber-based adhesives; and paper products such as paper comprising, or coated with, silicone, polyethylene, or polypropylene.

### CROSS REFERENCE TO RELATED APPLICATIONS

This patent application claims priority to and the benefit of provisional U.S. Patent Application No. 63/386,985, filed on Dec. 12, 2022, the entirety of which is hereby incorporated herein by reference.

### FIELD OF THE DISCLOSURE

The present disclosure relates to a system, apparatus, and method for injection molding, and for recycling, materials such as plastics, adhesives, and paper products, including, but not limited to, for example: polyvinyl chloride (PVC) films such as monomeric, polymeric, plasticized PVC, non-plasticized PVC, and PVC blends; adhesives such as polyacrylate adhesives and rubber-based adhesives; and paper products such as paper comprising, or coated with, silicone, polyethylene, or polypropylene.

### BACKGROUND OF THE DISCLOSURE

Recycling processes are commonly used to convert waste materials into recyclates, which are raw materials that can be processed in waste recycling plants or materials recovery facilities for use in the production of new materials and products. The recycling processes separate the waste materials based on the type of material, including, for example, plastics, paper products, rubber products, glass, or metal. The recyclability of each waste material depends on the material's ability to reacquire the properties it had in its original state.

### SUMMARY OF THE DISCLOSURE

An unfulfilled need exists for a recycling solution that can process and recycle multiple types of materials together to create mixed-content-recyclates (MCRs) that can be used as raw materials for products, such as, for example, packaging consumable products and consumer products. The disclosure provides a novel recycling solution that satisfies the need. The recycling solution includes a system, an apparatus and a computer-implemented method, for processing two or more types of materials to create MCRs.

In some non-limiting embodiments, a system is provided for recycling waste, the system comprising: a plurality of input streams, including a mixture stream and at least one of a rigid waste stream and a non-rigid waste stream; a granulator configured to receive the mixture stream and process the mixture stream to output a granulated material stream; a pelletizer configured to receive and process at least one of the rigid waste stream and the non-rigid waste stream to output at least one pelletized material stream; and a blender configured to receive and process the granulated material stream and the at least one pelletized material stream to output a mixed-content-recyclate (MCR). The system can further comprise an injection molder configured to receive the MCR and make a product through an injection molding process.

In some non-limiting embodiments, an apparatus is provided for recycling waste, the apparatus comprising: a granulator configured to receive a mixture stream and process the mixture stream to output a granulated material stream; a pelletizer configured to receive and process at least one of a rigid waste stream and a non-rigid waste stream to output at least one pelletized material stream; and a blender configured to receive and process the granulated material stream and the at least one pelletized material stream to output MCRs. The apparatus can comprise an injection molder configured to receive the MCRs and make a product through an injection molding process.

In some non-limiting embodiments, a computer-implemented method is provided for recycling waste, the method comprising: receiving a plurality of input streams, including a mixture stream and at least one of a rigid waste stream and a non-rigid waste stream; processing the mixture stream to output a granulated material stream; processing the at least one of the rigid waste stream and the non-rigid waste stream to output at least one pelletized material stream; and blending the granulated material stream and the at least one pelletized material stream to make an MCR. The method can comprise outputting the MCR. The method can comprise injection molding the MCR to make a product comprising the MCR.

In an embodiment of the disclosure, a system is provided for recycling waste, comprising: a plurality of input streams, including a mixture stream and at least one of a rigid waste stream and a non-rigid waste stream; a granulator configured to receive the mixture stream and process the mixture stream to output a granulated material stream; a pelletizer configured to receive and process the at least one of the rigid waste stream and the non-rigid waste stream to output at least one pelletized material stream; and a blender configured to receive and process the granulated material stream and the at least one pelletized material stream to output a mixed-content-recyclate (MCR), wherein the rigid waste stream contains rigid polyvinyl chloride (RPVC) and the non-rigid waste stream contains plasticizer.

The system can further comprise: an injection molder configured to receive the output mixed-content-recyclate (MCR) and form a product through an injection molding process; and/or a mixed-content-recyclate (MCR) controller having a processor and a storage; and/or a mixture stream control unit having a mixture stream input that receives the mixture stream and a mixture stream output that supplies the mixture stream to the granulator, wherein the mixture stream control unit monitors or adjusts at least one of an amount, a speed, and a flow-through rate of the mixture stream to the mixture stream output.

The system can comprise a rigid waste stream control unit having a rigid waste stream input that receives the rigid waste stream and a rigid waste stream output that supplies the rigid waste stream to the pelletizer, wherein the rigid waste stream control unit monitors or adjusts at least one of an amount, a speed, and a flow-through rate of the rigid waste stream to the rigid waste stream output.

The system can comprise a non-rigid waste stream control unit having a non-rigid waste stream input that receives the non-rigid waste stream and a non-rigid waste stream output that supplies the non-rigid waste stream to the pelletizer, wherein the non-rigid waste stream control unit monitors or adjusts at least one of an amount, a speed, and a flow-through rate of the non-rigid waste stream to the non-rigid waste stream output.

In the system, the output mixed-content-recyclate (MCR) can contain between 1% and 50% customer waste, between 1% and 98% rigid polyvinyl chloride (RPVC), and between 1% and 98% soft rigid polyvinyl chloride (SPVC).

In the system, the output mixed-content-recyclate (MCR) can contain 1%-33% customer waste, 1%-99% rigid polyvinyl chloride (RPVC), and 1%-80% non-rigid polyvinyl chloride (SPVC).

In a further embodiment of the disclosure, an apparatus is provided for recycling waste, the apparatus comprising: a granulator configured to receive a mixture stream and process the mixture stream to output a granulated material stream; a pelletizer configured to receive and process at least one of a rigid waste stream and a non-rigid waste stream to output at least one pelletized material stream; and a blender configured to receive and process the granulated material stream and the at least one pelletized material stream to output a mixed-content-recyclate (MCR), wherein the rigid waste stream contains rigid polyvinyl chloride (RPVC) and the non-rigid waste stream contains a plasticizer.

The apparatus can further comprise: an injection molder configured to receive the output mixed-content-recyclate (MCR) and form a product through an injection molding process; and/or a mixed-content-recyclate (MCR) controller having a processor and a storage.

The apparatus can further comprise: a mixture stream control unit having a mixture stream input that receives the mixture stream and a mixture stream output that supplies the mixture stream to the granulator; a rigid waste stream control unit having a rigid waste stream input that receives the rigid waste stream and a rigid waste stream output that supplies the rigid waste stream to the pelletizer; and a non-rigid waste stream control unit having a non-rigid waste stream input that receives the non-rigid waste stream and a non-rigid waste stream output that supplies the non-rigid waste stream to the pelletizer, wherein at least one of the mixture stream control unit, the rigid waste stream control unit, and the non-rigid waste stream control unit monitors or adjusts at least one of an amount, a speed, and a flow-through rate.

In the apparatus, the at least one of the mixture stream control unit, the rigid waste stream control unit, and the non-rigid waste stream control unit that monitors can include one or more sensors that measure weight and speed as a function of time.

In the apparatus, the output mixed-content-recyclate (MCR) can contain: between 1% and 50% customer waste, between 1% and 98% rigid polyvinyl chloride (RPVC), and between 1% and 98% soft rigid polyvinyl chloride (SPVC); or 1%-33% customer waste, 1%-99% rigid polyvinyl chloride (RPVC), and 1%-80% soft rigid polyvinyl chloride (SPVC).

In a further embodiment of the disclosure, a method is provided for recycling waste, the method comprising: receiving a plurality of input streams, including a mixture stream and at least one of a rigid waste stream and a non-rigid waste stream; processing the mixture stream to output a granulated material stream; processing the at least one of the rigid waste stream and the non-rigid waste stream to output at least one pelletized material stream; and blending the granulated material stream and the at least one pelletized material stream to make a mixed-content-recyclate (MCR), wherein the rigid waste stream contains rigid polyvinyl chloride (RPVC) and the non-rigid waste stream contains plasticizer.

The method can further comprise supplying the mixed-content-recyclate (MCR) to an injection molding processing; and, forming a product comprising the mixed-content recyclate (MCR).

The method can further comprise monitoring weight as a function of time in at least one of the mixture stream and the at least one of the rigid waste stream and the non-rigid waste stream; and adjusting at least one of an amount, a speed, and a flow through rate of at least one of the mixture stream and the at least one of the rigid waste stream and the non-rigid waste stream.

In the method, the at least one of the amount, the speed, and the flow through rate can be adjusted to make the mixed-content-recyclate (MCR) contain between 1% and 50% customer waste, between 1% and 98% rigid polyvinyl chloride (RPVC), and between 1% and 98% soft rigid polyvinyl chloride (SPVC).

In the method, the at least one of the amount, the speed, and the flow through rate can be adjusted to make the mixed-content-recyclate (MCR) contain 1%-33% customer waste, 1%-99% rigid polyvinyl chloride (RPVC), and 1%-80% soft rigid polyvinyl chloride (SPVC).

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 depicts a block diagram of an embodiment of a system constructed according to the principles of the disclosure.

FIG. 2 depicts a block diagram of an embodiment of a mixed-content-recyclate (MCR) controller that can be included in the system depicted in FIG. 1.

FIG. 3 depicts a recycling process, according to the principles of the disclosure.

FIG. 4 depicts a cross-sectional view of an embodiment of a granulator that can be included in the system depicted in FIG. 1.

FIG. 5 depicts a cross-sectional view of an embodiment of a pelletizer that can be included in the system depicted in FIG. 1.

FIG. 6 depicts an embodiment of a blender that can be included in the system depicted in FIG. 1.

FIG. 7 depicts an embodiment of a packaging consumable product created from MCR.

FIG. 8 depicts an embodiment of an injection molder that can be included in the system depicted in FIG. 1.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

The disclosure provides a solution for making standard products from multiple different types of recyclable materials to meet strength and durability requirements. Conventional wisdom believes that recyclable materials (such as, for example, plastics) need to be separated from other recyclable materials (such as, for example, different types of plastics, or glass, or paper) in order to be recycled or reused. The solution provided herein allows the different types of materials to be mixed together to form new products, thereby reducing/eliminating the waste going into landfills.

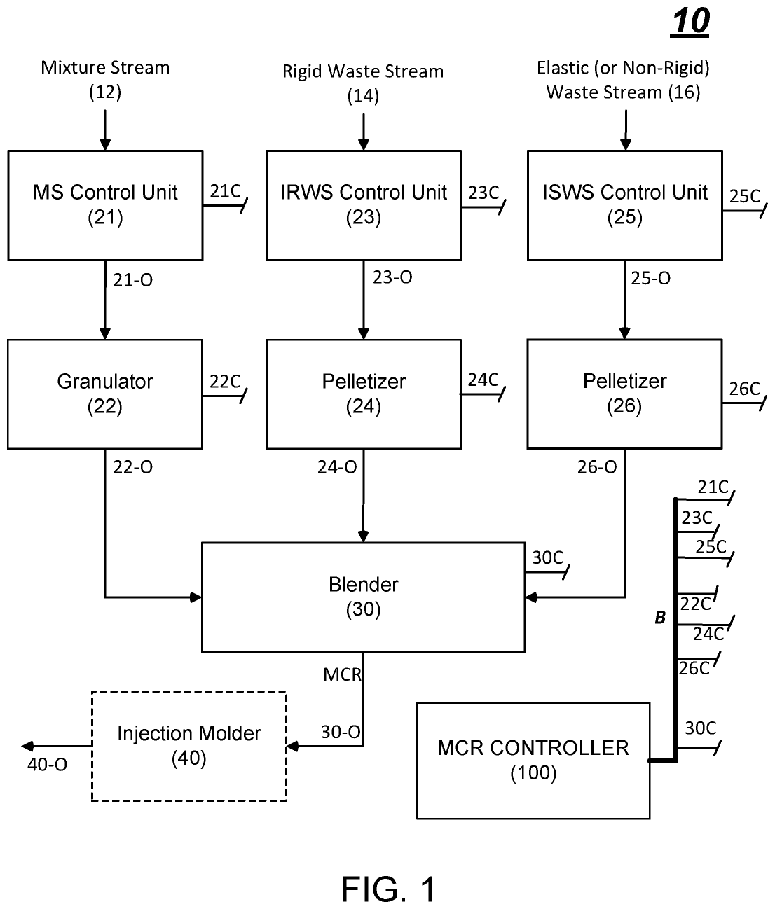

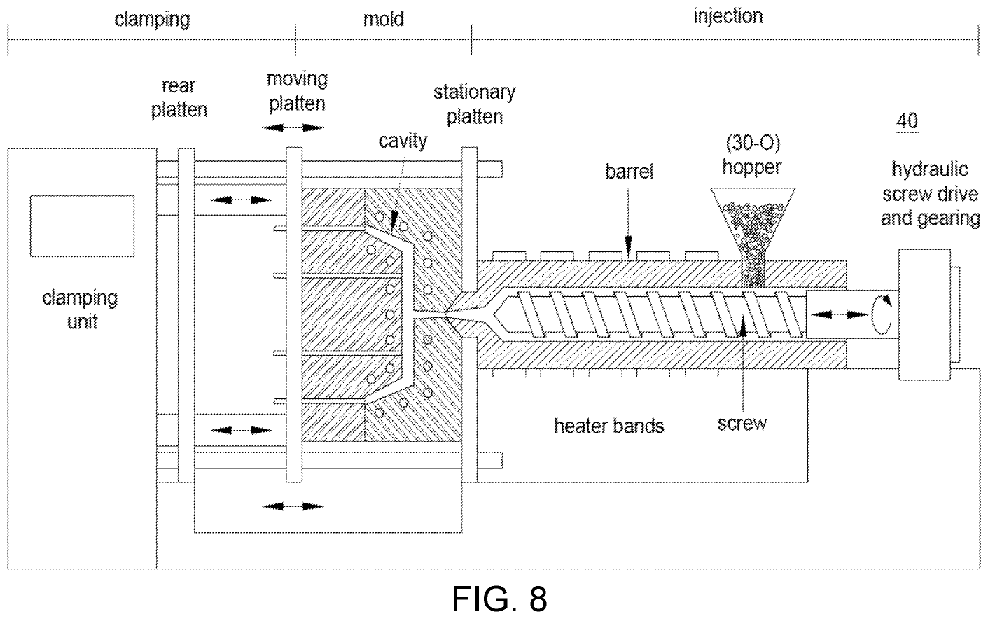

FIG. 1 depicts a non-limiting embodiment of a mixed-content-recyclate (MCR) system (10) for recycling two or more different types of material to output a mixed-content-recyclate (MCR, 30-O). The MCR system (10) comprises a plurality of input streams (12, 14, 16), a mixture stream (MS) control unit (21), a rigid waste stream (IRWS) control unit (23), a non-rigid (or elastic) waste stream (ISWS) control unit (25), a granulator (22), a pelletizer (24 and/or 26), and a blender (30). The system (10) can include an injection molder (40) configured to receive the MCR (30-O) and, via an injection molding process, mold a product comprising the MCR, such as, for example, a package, a container, a bottle, a bottle cap, an automotive part, a toy, composite lumber, or other item. The MCR (30-O) can be input to the injection molder (40) in the form of pellets and/or granules, which can be input into a hopper, moved forward by a screw-type plunger, and forced into a heater chamber, as seen, for example, in FIG. 8. The melted MCR (30-O) can be injected into a mold cavity to form the product. In certain embodiments, the input streams 14, 16 can include a rigid waste stream 14 and a non-rigid (or elastic or soft) waste stream 16.

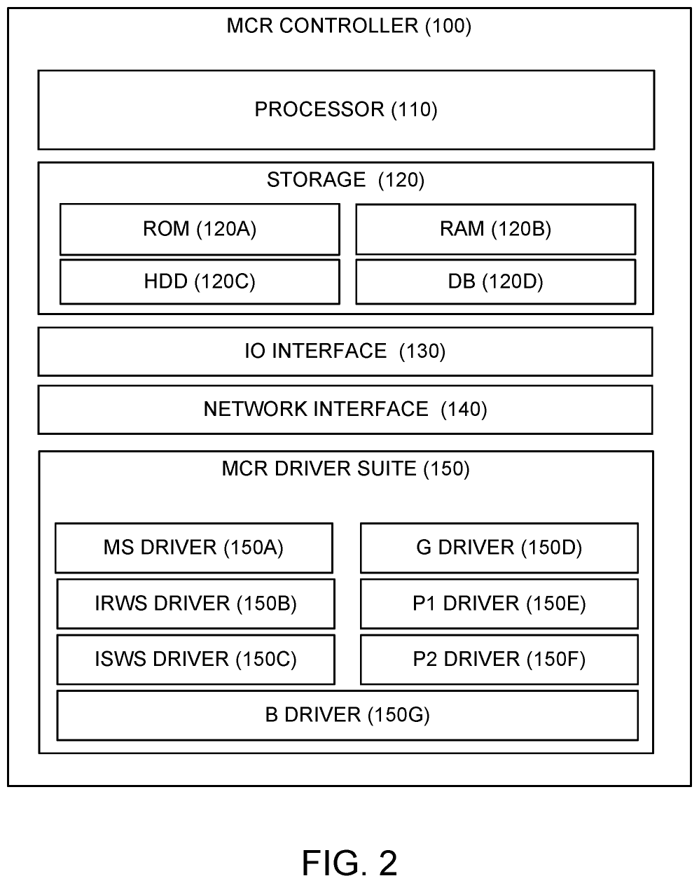

In various embodiments, the MS control unit (21), IRWS control unit 23, and ISWS control unit 25 can each include a transport device (such as, for example, one or more conveyor belts, guides, walls, and hoppers), a driver (such as, for example, a motor), a gateway (such as, for example, a gate, a movable wall or barrier, a door), or cutting device (such as, for example, a cutting blade), any of which can operate in response to signals (for example, instruction and data signals) received from the MCR driver suite 150 (shown in FIG. 2). Each of the MS control unit (21), IRWS control unit 23, and ISWS control unit 25 can include one or more sensors that measure temperature, pressure, humidity, gases, speed, and rate, and send measurement signals to a mixed-content recyclate (MCR) controller.

The system (10) can include a mixed-content-recyclate (MCR) controller (100). The MCR controller (100) can be connected via a communication link (21C, 22C, 23C, 24C, 25C, 26C, or 30C) to the MS control unit (21), IRWS control unit (23), ISWS control unit (25), granulator (22), pelletizer (24 and/or 26), or blender (30). The MCR controller (100) can be configured to generate and send signals (including instructions and data) to the various components (21-26, 30) in the MCR system (10) to control the granulation, palletization processes, and blending processes, as well as the inputs to those processes (12, 14, 16, 21-O, 23-O, 25-O, 22-O, 24-O, 26-O).

Each of the components (21, 22, 23, 24, 25, 26, 30, 40, 100) in the MCR system (10) can include a computing device or a communication device that can execute computer program instructions to carry out the processes disclosed herein. Each of the components (21, 22, 23, 24, 25, 26, 30, 40, 100) can be connected to a bus (B). Alternatively (or additionally), each of the components (21, 22, 23, 24, 25, 26, 30, 40, 100) can include a communication device configured to communicate via one or more communication links on a network.

In an embodiment, the plurality of input streams include a mixture stream (12), a rigid waste (IRW) stream (14), and a non-rigid waste (ISW) stream (16). The mixture stream (12) can include a waste stream comprising any combination of, for example, a PVC film, a monomeric film, a polymeric film, a blend of monomeric and polymeric films, a polyacrylate adhesive, a rubber-based adhesive, paper, silicone-coated paper, polyethylene material, propylene material, or other recyclable material. The rigid waste stream (14) can include a rigid PVC (or RPVC) waste stream. The non-rigid waste stream (16) can include a soft PVC (SPVC) waste stream. The rigid waste stream (14) and the non-rigid waste stream (16) can include either a plasticized PVC or a non-plasticized PVC.

In various embodiments, the rigid waste stream (14) contains non-plasticized PVC. The non-plasticized PVC contains between 0% and 5% plasticizer by weight. The rigid waste stream (14) can also include, for example, semi-rigid films (for example, about 6% to about 12% plasticizer).

In various embodiments, the non-rigid waste stream (16) contains SPVC. The SPVC contains PVC and a plasticizer such as, for example, phthalate, organophosphate, adipate, trimellitate, polymeric plasticizer, epoxidized vegetable oil, diisononyl phthalate (DINP), diisobutyl phthalate (DIBP), bis(2-ethylhexyl) phthalate (DEHP), dibutyl phthalate (DBP), butyl benzyl phthalate (BBzP), bis(2-propylheptyl) phthalate (DPHP), diisodecyl phthalate (DIDP), diisoundecyl phthalate (DIUP), ditridecyl phthalate (DTDP), dioctyl terephthalate (DOTP), diisopentyl terephthalate (DiPT), dibutyl terephthalate (DBT), tri(2-ethylhexyl)trimellitate (TEHTM), trioctyl trimellitate (TOTM), tri(isononyl)trimellitate (TINTM), tri(isodecyl)trimellitate (TIDTM), tri(isotridecyl)trimellitate (TITDTM), bis(2-ethylhexyl)adipate (DEHA), dibutyl sebacate (DBS), di(2-ethylhexyl)sebacate, di-octyl Sebacate, tricresyl phosphate (TCP), or the like. The SPVC can include between about 15% and 40% plasticizer by content weight. SPVC containing less than 15%, or more than 40%, is contemplated. The rigid waste stream (14) can include, for example, 0 to 15% by weight of plasticizer.

FIG. 2 depicts a block diagram of an embodiment of the MCR controller (100), constructed according to the principles of the disclosure. The MCR controller (100) includes a processor (110), a storage (120), an input-output (IO) interface (130), a network interface (140), and a mixed-content-recyclate (MCR) driver suite (150), all of which can connect to a bus (not shown). The MCR controller (100) can include one or more devices such as, for example, a transmitter, a receiver, a transceiver, a modulator, a demodulator, a modem, an encoder, a decoder, or a codec.

The processor (110) can include a computing device, such as, for example, any of various commercially available graphic processing unit devices. Dual microprocessors and other multi-processor architectures can be included in the processor (110). The processor (110) can include a central processing unit (CPU), a graphic processing unit (GPU), a general-purpose GPU (GPGPU), a field programmable gate array (FGPA), an application-specific integrated circuit (ASIC), or a manycore processor.

The processor (110) is configured to process instructions for execution within the MCR system (10), including instructions stored in the storage (120). The processor (110) can process instructions to display graphical information for a graphic user interface (GUI) on an external input/output device, such as a display device (not shown) coupled to the IO interface (130), which can include a high-speed interface.

The storage (120) can include a read-only-memory (ROM) (120A), a random-access-memory (RAM) (120B), a hard-disk-drive (HDD) (120C), and a database (DB) (120D). The storage (120) can include a non-transitory computer-readable medium that can hold executable or interpretable computer program code or instructions that, when executed by the processor (110), can cause the steps, processes and methods in this disclosure to be carried out.

A basic input/output system (BIOS) can be stored in the non-volatile memory, which can include the ROM (120A). The ROM (120A) can include an erasable programmable rea-only memory (EPROM) or an electrically erasable programmable read-only memory (EEPROM). The BIOS can contain the basic routines that help to transfer information and instructions between the components (110-150) in the MCR controller (100), such as during start-up.

The RAM (120B) can include a dynamic random-access memory (DRAM), a synchronous dynamic random-access memory (SDRAM), a static random-access memory (SRAM), a non-volatile random-access memory (NVRAM), or another high-speed RAM for caching data.

The HDD (120C) can include an enhanced integrated drive electronics (EIDE) drive or any suitable hard disk drive for use with big data. The HDD (120C) can be configured for external use in a suitable chassis (not shown). The HDD (120C) can be connected to the bus by a hard disk drive interface (not shown) and an optical drive interface (not shown), respectively. The hard disk drive interface (not shown) can include a Universal Serial Bus (USB) (not shown), an IEEE 1394 interface (not shown), or any other suitable interface for external applications.

The DB (120D) can be configured to contain information about each component in the MCR system (10, shown in FIG. 1), including each component in the MCR controller (100) and the network (not shown). The DB (120D) can contain information for each component, such as, for example, specification data, an Internet Protocol (IP) address, a media access control (MAC) address, or an electronic address at which the associated component can be accessed.

The storage (120) can provide nonvolatile storage of data, data structures, and computer-executable code or instructions. The storage (120) can accommodate the storage of any data in a suitable digital format. The storage (120) can include one or more computer resources that can be used to execute aspects of the architecture described herein.

One or more computer resources can be contained in the storage (120), including an operating system (not shown), one or more application programs (not shown), one or more application program interfaces (APIs), and program data (not shown). The APIs can include, for example, JSON APIs, XML APIs, Web APIs, SOAP APIs, RPC APIs, REST APIs, or other utilities or services APIs. Any (or all) of the computer programs can be cached in the RAM (120B) as executable sections of computer program code.

The IO interface (130) can be arranged to receive commands and data from the processor (110), or a communicating device (not shown) located external to the MCR controller (100), which can be interacted with by a user. The IO interface (130) can connect to or communicate with one or more input/output devices (not shown), including, for example, a keyboard (not shown), a mouse (not shown), a pointer (not shown), a microphone (not shown), a speaker (not shown), or a display device (not shown). The received commands and data can be forwarded from the IO interface (130) as instruction and data signals via the bus to any computer device in the MCR system (10, shown in FIG. 1).

The network interface (140) can connect to a network (not shown). The MCR controller (100) can connect to one or more communicating devices in the MCR system (10, shown in FIG. 1) via the network interface (140) communicating with each communicating device over a communication link. The network interface (140) can be connected to the network via one or more communication links. The network interface (140) can include a wired or a wireless communication network interface (not shown) or a modem (not shown). When used in a local area network (LAN), the MCR controller (100) can be connected to the LAN network through the wired or wireless communication network interface; and, when used in a wide area network (WAN), it can be connected to the WAN network through the modem. The network can include a LAN, a WAN, the Internet, or any other network. The modem (not shown) can be internal or external and wired or wireless. The modem can be connected to the bus via, for example, a serial port interface (not shown).

The MCR driver suite (150) can include one or more driver units (150A-150F), each of which can interact with a controllable component (21, 23, 25, 22, 24, 26, or 30) in the MCR system (10). In an embodiment, the MCR driver suite (150) includes a mixed-stream (MS) driver 150A, a rigid waste stream (IRWS) driver (150B), a non-rigid waste stream (ISWS) driver (150C), a granulator (G) driver (150D), a first pelletizer (P1) driver (150E), a second pelletizer (P2) driver (150F), and a blender (B) driver (150G). Each of the drivers (105A-150G) can be operated under control of the processor (110) to generate and send control signals to the respective, associated component (21, 23, 25, 22, 24, 26, or 30, respectively) in the MCR system (10) via an associated communication link (21C, 23C, 25C, 22C, 24C, 26C, or 30C, respectively).

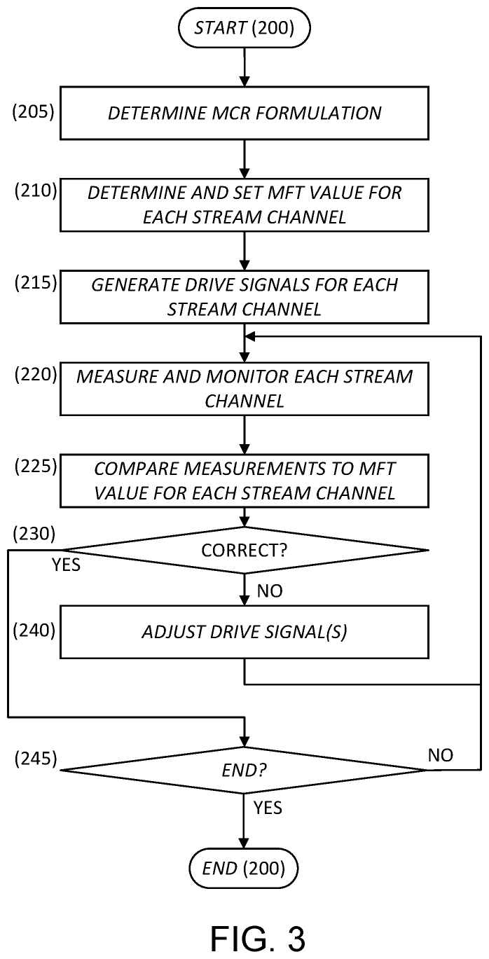

FIG. 3 depicts a recycling process (200), according to the principles of the disclosure. The MCR controller (100) can be configured to carry out the process (200), including determining, by the processor (110), the desired makeup of the MCR output (30-O) (Step 205) and a material flow through (MFT) value for each stream channel (Step 210). In various embodiments, the MCR output (30-O) can be determined to include, for example, between 1% and 50% customer waste (mixture stream 12), between 1% and 98% RPVC (IRWS 14), and between 1% and 98% SPVC (ISWS 16).

In at least one embodiment, the MCR output (30-O) can include 1%-50% customer waste, 1%-99% RPVC, and 1%-80% SPVC, wherein the total amount of customer waste, RPVC, and SPVC can total 100% of MCR output content. Accordingly, if MCR output contains 45% customer waste (CW) of total content weight, 40% RPVC of total content weight, then the SPVC amount can be determined and set to about 15% SPVC of total content weight. The ratios of CW:RPVC:SPVC can be set or adjusted by the MCR controller (100) based on an available amount of CW, RPVC, or SPVC, the properties of the CW, RPVC, SPVC, or a predetermined property for the CMR output (30-O) such as, for example, weight, density, specific gravity, shore hardness, flexural stiffness, tensile strength, elongation at break, or the like.

In various embodiments, the MCR output (30-O) contains 1%-33% CW, 1-99% RPVC, and 1%-80% SPVC. In at least one embodiment, the MCR output (30-O) contains a total 100% of weight % of CW+weight % of RPVC+weight % of SPVC=100% of weight of MCR output.

In the embodiment depicted FIG. 1, the MCR system (10) has three stream channels, comprising: a first channel (CH1) that includes the mixture stream (12), the MS control unit (21), the granulator (22), and the blender (30); a second channel (CH2) that includes the IRWS (14), the IRWS control unit (23), the pelletizer (24), and the blender (30); and a third channel (CH3) that includes the ISWS (16), the ISWS control unit (25), the pelletizer (26), and the blender (30). The amount, rate, and speed of material flowing through each stream channel necessary to achieve the determined MCR output (30-O) formulation can be determined and preset as the MFT value for that channel (Step 210).

For example, for an MCR output (30-O) containing 40% CW+35% RPVC+25% SPVC, the amount, rate, and speed of material flowing through the channels CH1, CH2, and CH3 can be determined and controlled by the MCR controller (100) such that the predetermined weight % of each of CW, RPVC, and SPVC are achieved, which in this example is 40% CW, 35% RPVC, and 25% SPVC. As noted above, the ratio of CW:RPVC:SPVC can be set or adjusted by the MCR controller (100) based on predetermined properties of the CMR output (30-O), including, for example, weight, density, specific gravity, shore hardness, flexural stiffness, tensile strength, elongation at break, or the like.

After the formulation of the MCR output (30-O) is determined (Step 205) and the MFT values set for each stream channel (CH1, CH2, CH3), the MCR driver suite 150 can operate to generate drive signals for each channel, via the drivers (150A-150G), including each associated component (21, 23, 25, 22, 24, 26, 30) in the MCR system (10) to create the MCR formulation at the MCR output (30-O) of the blender (30) (Step 215).

The rate, speed, and amount of material flowing in each stream channel can be measured in each stream channel in the MCR system (10) and monitored by the MCR controller (100) (Step 220). The measurements can be carried out by one or more sensors included in the MS, IRWS, and ISWS control units (21, 23, 25), the granulator (22), the pelletizers (24, 26), and the blender (30). The MCR controller (100) can receive measurement signals from each sensor and monitor the rate, speed and amount of material flowing in real time, and at each instant of time, through each measured component (21-26, 30) in the MCR system (10) (Step 220).

As each stream channel is monitored (Step 220), the measurement can be compared against the respective predetermined MFT value (Step 225) and a determination made whether correction is necessary (Step 230). If it is determined that the amount, rate, or speed of material in one or more of the stream channels needs to be adjusted (YES at Step 230), then the associate drive signal(s) can be adjusted (Step 240) and the stream channels can continue to be measured and monitored (Step 220), otherwise (NO at Step 230) a determination can be made whether to end the process (200) (Step 245).

If it is determined the process (200) should end (YES at Step 245), the process is ended, otherwise (NO at Step 245) the process (200) can repeat (Steps 220-245).

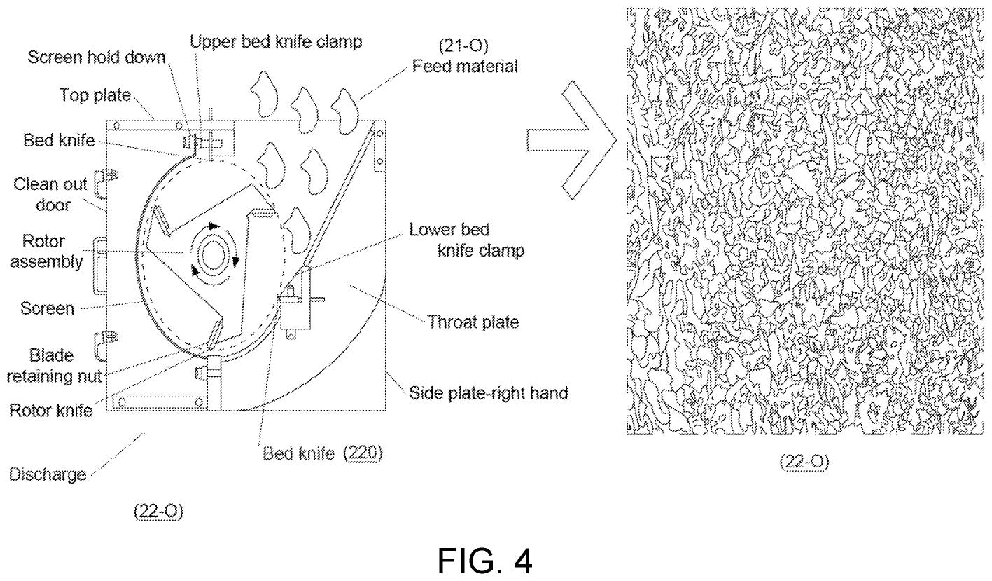

FIG. 4 depicts a non-limiting embodiment of the granulator (22). The granulator (22), which can operate under control of the MCR controller (100) via the communication link 22C, can include, in combination, at least one of a screen hold down top plate, a bed knife, a clean out door, a rotor assembly, a screen, a blade retaining nut, a rotor knife, an upper bed knife clamp, a lower bed knife clamp, a throat plate, a side plate, and a bed knife. The granulator (22) can receive the mixture stream output (21-O) as a feed material (22-I), process the feed material and discharge a granulated stream (22-O) comprising a mixture of, for example, plastic elements and paper elements.

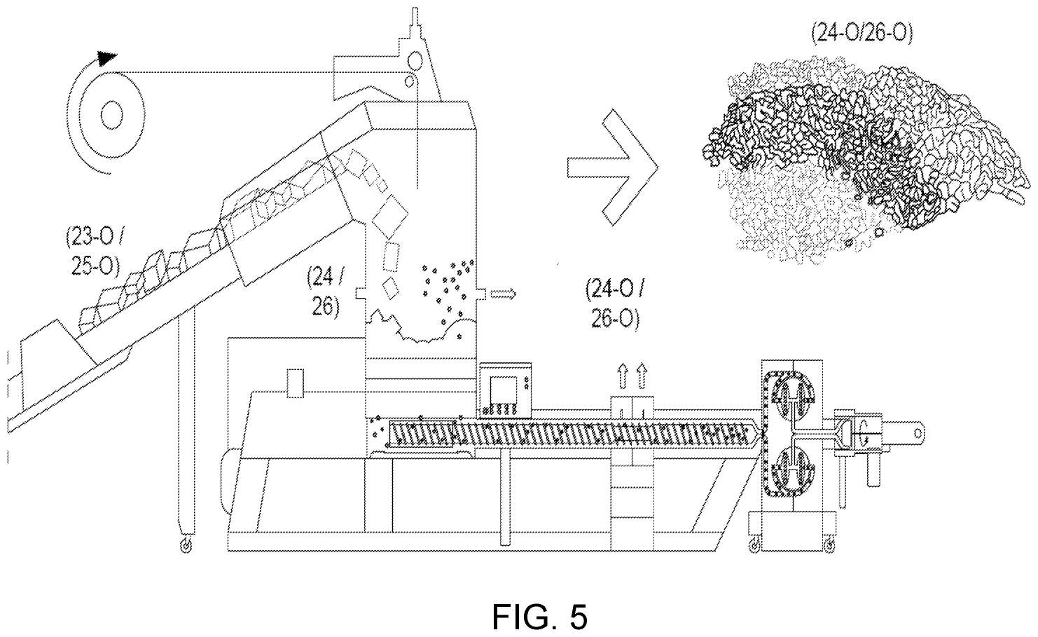

FIG. 5 depicts a non-limiting embodiment of the pelletizer (24, 26). The pelletizer (24, 26) can include the structure depicted in FIG. 5. In at least one embodiment, the MCR system (10) comprises at least two pelletizers (24, 26). Each pelletizer (24, 26) can include, for example, an INTAREMA® recycling device by EREMA GmbH. The pelletizer (24/26) can receive and process at least one of the IRWS output (23-O) and the ISWS output (25-O) to generate and output at least one pelletized recycle stream (24-O and/or 26-O).

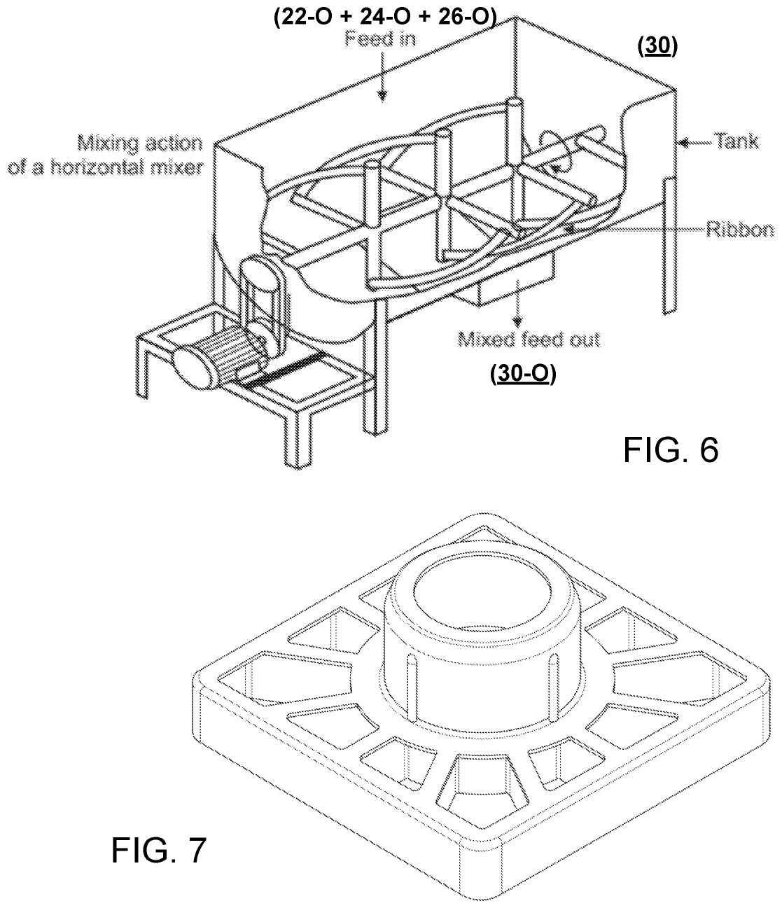

FIG. 6 depicts a non-limiting embodiment of the blender (30), which can receive the granulated stream (22-O) and the pelletized streams (24-O and/or 26-O) from the granulator (22) and pelletizers (24, 26), process the received materials via, for example, a mixing action of a horizontal mixer, and output the MCR (30-O). In the illustrated embodiment, the blender (30) includes a tank that receives, via a feed-in opening, and holds the granulated and pelletized streams as a mixing operation is carried out by a horizontal mixer included in the tank, which includes a ribbon.

In the embodiment depicted in FIG. 1, the output (30-O) of the blender (30) can be supplied to the injection molder (40), which can operate to mold and form one or more products.

FIG. 7 depicts an example of a product made by the injection molder (40) using the MCR output (30-O). The example is an end cap made of mixed-content-recyclate (MCR) that can be used to suspend pressure-sensitive materials during transit.

FIG. 8 depicts a nonlimiting embodiment of the injection molder (40) included in the MCR system (10, shown in FIG. 1). In the embodiment, the injection molder (40) includes a 3-stage molder that has an injection stage, a mold stage, and a clamping stage.

The injection stage includes a hopper, a hydraulic screw drive and gearing, a screw, a barrel having a chamber, and a plurality of heater bands. The injection stage is configured to receive the MCR (30-O) via the hopper and supply the MCR to the barrel chamber, where the screw turns and forces the MCR downstream in the chamber as heat is applied by the heater bands, thereby melting the MCR to a fluid, which is then output to the mold stage.

The mold stage includes a stationary platten, cavity, and moving platten. The fluid MCR is injected into the cavity, which is formed by (and between) the stationary platten and the moving platten. Upon completion of injection of the fluid MCR into the cavity, the fluid MCR is cooled to form a product. The moving platten can then be moved to release the product. At least one of the moving platten and the stationary platten includes a mold form that forms the shape, size and texture of the product.

The clamping stage includes a rear platten and a clamping unit. The clamping unit operates and drives the moving platten throughout the mold stage, including (1) driving the moving platten toward the stationary platten to form the cavity, (2) holding the moving platten during the injection of fluid MCR into the cavity and cooling of the injected MCR in the cavity, and (3) withdrawing the moving platten away from the stationary platten to open the cavity and release the product formed by the molded MCR. For cooling, the cavity can be surrounded by a network of cooling conduits.

The clamping unit can include a motor, a hydraulic drive, or a pneumatic drive.

As seen in FIG. 8, the injection molder (40) can receive the MCR output (30-O) via the hopper and force the MCR into a heat chamber, where the MCR can be melted and subsequently injected into the cavity to form the product comprising the MCR.

In various applications, using the injection molder (40), standard products can be made from multiple, different types of recyclable materials to meet strength and durability requirements.

The terms “a,” “an,” and “the,” as used in this disclosure, means “one or more,” unless expressly specified otherwise.

The term “backbone,” as used in this disclosure, means a transmission medium or infrastructure that interconnects one or more computing devices or communication devices to provide a path that conveys data packets and instruction signals between the one or more computing devices or communication devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “communicating device,” as used in this disclosure, means any computing device, hardware, or computing resource that can transmit or receive data packets, instruction signals or data signals over a communication link. The communicating device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, 5G or 6G cellular standards, satellite, or Bluetooth. A communication link can include, for example, an RS-232, RS-422, RS-485, or any other suitable interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), a data processing unit (DPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, 5G, or 6G cellular standards, or Bluetooth.

The terms “computer resource” or “computing resource,” as used in this disclosure, mean software, a software application, a web application, a web page, a computer application, a computer program, computer code, machine executable instructions, firmware, or a process that can be arranged to execute on a computing device or a communicating device.

The term “computing resource process,” as used in this disclosure, means a computing resource that is in execution or in a state of being executed on an operating system of a computing device, such as, for example, the processor 110 (shown in FIG. 2). Every computing resource that is created, opened or executed on or by the operating system can create a corresponding computing resource process. A computing resource process can include one or more threads, as will be understood by those skilled in the art.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application can include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and variations thereof, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The term “transmission” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for recycling waste, comprising:
a plurality of input streams, including a mixture stream and at least one of a rigid waste stream and a non-rigid waste stream;
a granulator configured to receive the mixture stream and process the mixture stream to output a granulated material stream;
a pelletizer configured to receive and process the at least one of the rigid waste stream and the non-rigid waste stream to output at least one pelletized material stream; and
a blender configured to receive and process the granulated material stream and the at least one pelletized material stream to output a mixed-content-recyclate (MCR),
wherein the rigid waste stream contains rigid polyvinyl chloride (RPVC) and the non-rigid waste stream contains plasticizer.

2. The system in claim 1, further comprising an injection molder configured to receive the output mixed-content-recyclate (MCR) and form a product through an injection molding process.

3. The system in claim 1, further comprising a mixed-content-recyclate (MCR) controller having a processor and a storage.

4. The system in claim 1, further comprising:
a mixture stream control unit having a mixture stream input that receives the mixture stream and a mixture stream output that supplies the mixture stream to the granulator,
wherein the mixture stream control unit monitors or adjusts at least one of an amount, a speed, and a flow-through rate of the mixture stream to the mixture stream output.

5. The system in claim 1, further comprising:
a rigid waste stream control unit having a rigid waste stream input that receives the rigid waste stream and a rigid waste stream output that supplies the rigid waste stream to the pelletizer,
wherein the rigid waste stream control unit monitors or adjusts at least one of an amount, a speed, and a flow-through rate of the rigid waste stream to the rigid waste stream output.

6. The system in claim 1, further comprising:
a non-rigid waste stream control unit having a non-rigid waste stream input that receives the non-rigid waste stream and a non-rigid waste stream output that supplies the non-rigid waste stream to the pelletizer,
wherein the non-rigid waste stream control unit monitors or adjusts at least one of an amount, a speed, and a flow-through rate of the non-rigid waste stream to the non-rigid waste stream output.

7. The system in claim 1, wherein the output mixed-content-recyclate (MCR) contains between 1% and 50% customer waste, between 1% and 98% rigid polyvinyl chloride (RPVC), and between 1% and 98% soft rigid polyvinyl chloride (SPVC).

8. The system in claim 1, wherein the output mixed-content-recyclate (MCR) contains 1%-33% customer waste, 1%-99% rigid polyvinyl chloride (RPVC), and 1%-80% soft rigid polyvinyl chloride (SPVC).

9. An apparatus for recycling waste, comprising:
a granulator configured to receive a mixture stream and process the mixture stream to output a granulated material stream;
a pelletizer configured to receive and process at least one of a rigid waste stream and a non-rigid waste stream to output at least one pelletized material stream; and
a blender configured to receive and process the granulated material stream and the at least one pelletized material stream to output a mixed-content-recyclate (MCR),
wherein the rigid waste stream contains rigid polyvinyl chloride (RPVC) and the non-rigid waste stream contains a plasticizer.

10. The apparatus in claim 9, further comprising an injection molder configured to receive the output mixed-content-recyclate (MCR) and form a product through an injection molding process.

11. The apparatus in claim 9, further comprising a mixed-content-recyclate (MCR) controller having a processor and a storage.

12. The apparatus in claim 9, further comprising:
a mixture stream control unit having a mixture stream input that receives the mixture stream and a mixture stream output that supplies the mixture stream to the granulator;
a rigid waste stream control unit having a rigid waste stream input that receives the rigid waste stream and a rigid waste stream output that supplies the rigid waste stream to the pelletizer; and
a non-rigid waste stream control unit having a non-rigid waste stream input that receives the non-rigid waste stream and a non-rigid waste stream output that supplies the non-rigid waste stream to the pelletizer,
wherein at least one of the mixture stream control unit, the rigid waste stream control unit, and the non-rigid waste stream control unit monitors or adjusts at least one of an amount, a speed, and a flow-through rate.

13. The apparatus in claim 12, wherein the at least one of the mixture stream control unit, the rigid waste stream control unit, and the non-rigid waste stream control unit that monitors includes one or more sensors that measure weight and speed as a function of time.

14. The apparatus in claim 9, wherein the output mixed-content-recyclate (MCR) contains between 1% and 50% customer waste, between 1% and 98% rigid polyvinyl chloride (RPVC), and between 1% and 98% soft rigid polyvinyl chloride (SPVC).

15. The apparatus in claim 9, wherein the output mixed-content-recyclate (MCR) contains 1%-33% customer waste, 1%-99% rigid polyvinyl chloride (RPVC), and 1%-80% soft rigid polyvinyl chloride (SPVC).

16. A method for recycling waste, comprising:
receiving a plurality of input streams, including a mixture stream and at least one of a rigid waste stream and a non-rigid waste stream;
processing the mixture stream to output a granulated material stream;
processing the at least one of the rigid waste stream and the non-rigid waste stream to output at least one pelletized material stream; and
blending the granulated material stream and the at least one pelletized material stream to make a mixed-content-recyclate (MCR)
wherein the rigid waste stream contains rigid polyvinyl chloride (RPVC) and the non-rigid waste stream contains plasticizer.

17. The method in claim 16, further comprising:
supplying the mixed-content-recyclate (MCR) to an injection molding processing; and,
forming a product comprising the mixed-content recyclate (MCR).

18. The method in claim 16, further comprising:
monitoring weight as a function of time in at least one of the mixture stream and the at least one of the rigid waste stream and the non-rigid waste stream; and
adjusting at least one of an amount, a speed, and a flow through rate of at least one of the mixture stream and the at least one of the rigid waste stream and the non-rigid waste stream.

19. The method in claim 18, wherein the at least one of the amount, the speed, and the flow through rate are adjusted to make the mixed-content-recyclate (MCR) contain between 1% and 50% customer waste, between 1% and 98% rigid polyvinyl chloride (RPVC), and between 1% and 98% soft rigid polyvinyl chloride (SPVC).

20. The method in claim 18, wherein the at least one of the amount, the speed, and the flow through rate are adjusted to make the mixed-content-recyclate (MCR) contain 1%-33% customer waste, 1%-99% rigid polyvinyl chloride (RPVC), and 1%-80% soft rigid polyvinyl chloride (SPVC).
